(19) United States
(12) Patent Application Publication
(10) Pub. No.: US 2010/0224727 A1
(43) Pub. Date: Sep. 9, 2010

(54) SYSTEM AND A METHOD FOR MAKING FUNCTIONS AVAILABLE TO A PASSENGER

(76) Inventors: Hans-Achim Bauer, Hamburg (DE); Andre Zybala, Hanstedt (DE)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/718,293

(22) Filed: Mar. 5, 2010

Related U.S. Application Data
(60) Provisional application No. 61/158,103, filed on Mar. 6, 2009.

(51) Int. Cl. B64D 11/00

(52) U.S. Cl. 244/118.5

(57) ABSTRACT

A cabin management system for functions which are provided within a passenger compartment, in each seats of a passenger said system comprising a function control unit which has a switching unit for switching individually functions for the respective passenger on and off, wherein the passenger is authenticated by identification means with respect to said cabin management system, said function control units being connected by means of an on-board network to a server which communicates via a wireless interface with a service trolley comprising a display indicating a comfort class selected by the respective passenger to a flight attendant.

### CROSS-REFERENCE TO RELATED APPLICATIONS

This application claims the benefit of U.S. Provisional Application No. 61/158,103, filed Mar. 6, 2009, the entire disclosure of which is herein incorporated by reference.

### TECHNICAL BACKGROUND

The invention relates to a system and a method for making functions available to a passenger, in particular a cabin management system for airline passengers.

When people are transported in a means of conveyance or means of transport, the people or passengers to be transported are situated in a passenger compartment or cabin. The passenger seats provided in the cabin are equipped with functions. For example, passenger entertainment systems are used to an increasing extent in aircraft, which systems allow the passengers to watch films or to select music channels. In addition to passenger entertainment systems of this type, passenger communication systems are also provided in aircraft which make it possible for the passenger to conduct a telephone conversation with a person on the ground. In addition to seat adjusting systems which the passenger uses to adjust his seat according to his requirements, seat massage systems are sometimes also provided, particularly in first class, in which case actuators fitted in the surface of the seat massage the passenger on demand.

A cabin management system is provided for monitoring and controlling functions which are made available to the passengers within a passenger compartment or cabin. In conventional cabin management systems, as used in aircraft, they have a flight attendant panel FAP for the cabin crew or the flight attendants. This panel is usually installed at central points in the cabin, for example in the region of the doors.

A conventional cabin management system of this type can monitor and control service features or functions of, for example the passenger entertainment system, of a passenger communication system or of a power supply system.

However, in a conventional cabin management system, a passenger has no opportunity to adjust the provided service features or to request the provided functions individually according to his requirements.

When people or passengers are transported in aircraft, the passengers are usually divided into different categories or classes. During passenger transport in an aircraft, a distinction is usually made between what is known as first class, business class and economy class. These different comfort classes differ in the range and quality of the services provided and in the device functions offered in the particular seat. If a passenger decided on a specific comfort class when booking a flight, with the conventional cabin management system he would not have any influence over the functions according to his individual requirements. For example, while one passenger in economy class places particular importance on specific functions or services, another passenger in economy class does not make use of any functions at all to minimise the flight price he has paid. Therefore, conventional cabin management systems for passenger transport do not provide any possibility of an individual, personalised and optional activation of service features or functions in the cabin.

This is also a major disadvantage from the point of view of the operator of the respective passenger transport means, for example an airline, since for example one comfort class, say economy class is fully booked, while in another class, for example business class, seats are still available which are, however, not booked by potential users due to the higher price. This reduces the capacity utilisation of the flight.

### SUMMARY OF THE INVENTION

The invention provides a cabin management system for functions which are provided within a passenger compartment, a function control unit individually controlling functions for a passenger who is authenticated to the cabin management system by an identification means.

An advantage of the present invention is to make system functions individually available to the respective passenger.

In a possible embodiment of the cabin management system according to the invention, the identification means has a memory unit for storing the passenger's personal data and function control data for the selection of functions.

This function control data can be generated, for example when the passenger transport is booked or when the passenger checks in and it can be written into the memory unit of the identification means.

The function control data can be, for example service features or functions which the passenger selects from a predetermined list of service features according to his requirements. Alternatively, the passenger can select a comfort class when booking or during check-in, each comfort class having an associated range of functions. As a result of the passenger's personal data, for example name, age, height, it is also possible to provide in an optimised manner specific comfort functions for the respective passenger, for example an available seat or the distance of the seat from the next row of seats.

In a possible embodiment of the cabin management system according to the invention, the function control unit has a read unit for reading out the passenger's personal data stored on the identification means and the stored function control data. The read unit can be, for example a card read unit, the passenger inserting an identification card into the reader such that it can be read out. Alternatively, the function control data and the passenger's personal data can be read out wirelessly via an air interface.

In a possible embodiment of the cabin management system according to the invention, the identification means is the passenger's boarding pass or ticket. An advantage of using the boarding pass is that before commencing the journey, that is to say during booking, but even while checking in or boarding, service features can be optionally booked or selected by the passenger. A further advantage of using the boarding pass as the identification means is that the boarding pass already provides a clear seat allocation inside the cabin. Alternatively, a credit card, a service card or a loyalty card belonging to the respective passenger can also be used as the identification means.

In a possible embodiment of the cabin management system, the function control unit has a switching unit for switching functions off and on which are made available to the passenger by electronic units inside the passenger cabin. Therefore, in this embodiment, functions are activated or deactivated by the passenger.

In an embodiment of the cabin management system according to the invention, a respective function control unit is fitted to the seat of the respective passenger. This makes it possible for the passenger to conveniently configure the functions which he requires directly in his seat.

In an embodiment of the cabin management system according to the invention, the function control unit has a user interface with an input unit for inputting instructions by the passenger and with a display unit for displaying enabled functions.

In this embodiment, the user or passenger can have the functions displayed which he has booked or selected and, if applicable, can activate further functions according to his requirements by inputting instructions. In the same way, the user or passenger can also switch off functions which have been activated by mistake. In a possible embodiment, the passenger's fare is accordingly increased or reduced when functions are activated or deactivated.

In a possible embodiment of the cabin management system according to the invention, the functions are provided by an electronic passenger entertainment system, a communication system, a power supply system, a seat adjusting system or by a seat massage system.

In a possible embodiment of the cabin management system according to the invention, a seat space made available to a passenger in his seat is adjusted individually by the seat adjusting system subject to function control data which is saved on the passenger's identification means.

In this embodiment, it is possible for the passenger to adjust the space which he wants according to his requirements and, for example according to his height. For example, during a relatively long flight a relatively tall person can increase the distance of his seat from the row of seats in front, so that he is able to sit comfortably. Consequently, the seating distance is reduced accordingly for a person who is seated behind. This person can be, for example a relatively small person or a person who is satisfied with less space in order to make a saving in the cost of the flight.

In a possible embodiment of the cabin management system according to the invention, the function control units are connected to a server for the service personnel or the flight attendants by an on-board network. In this embodiment, the service personnel can detect via a display, for example which service features or functions are enabled or activated for the respective passenger. The service personnel can accordingly offer an available service.

In a possible embodiment of the cabin management system according to the invention, the passenger's personal data and the function data are generated when the passenger transport is booked and are written into the memory unit of the identification means. In an alternative embodiment, this data can be generated when the passenger checks in or boards and can be written into the memory unit.

In a possible embodiment of the cabin management system according to the invention, the function control data is generated as a function of a selected comfort class and written into the memory unit of the identification means.

The cabin management system according to the invention is suitable for any means of passenger transport, in particular for means of transport in which a plurality of people or passengers sits in a passenger compartment. The cabin management system according to the invention can be used, for example in aircraft, coaches, trains or ferries.

The invention further provides a method which has the features stated in claim 14.

The invention provides a method for making functions available to a passenger, which method has the following steps:
authentication of a passenger by an identification means carried by the passenger,
readout of function control data, saved on the identification means, by a function control unit, and
individual activation of functions by the function control unit subject to the function control data read out from the identification means.

### BRIEF DESCRIPTION OF FIGURES

In the following, embodiments of the cabin management system according to the invention and of the method according to the invention for making functions available to a passenger will be described with reference to the accompanying figures, in which:

FIG. 1 is a block diagram illustrating a function control unit used in the cabin management system according to the invention;

FIGS. 2A, 2B are block diagrams illustrating a possible embodiment of the cabin management system according to the invention;

FIG. 3 shows an example of use of the cabin management system according to the invention;

FIG. 4 is a flow chart of a possible embodiment of the method according to the invention for making functions available to a passenger;

FIG. 5 shows an example of use illustrating functions of the cabin management system according to the invention;

FIG. 6 shows an embodiment of the cabin management system according to the invention in which a plurality of function control units is networked via an on-board network;

FIGS. 7A, 7B show examples of use of the cabin management system according to the invention.

### DETAILED DESCRIPTION OF EMBODIMENTS

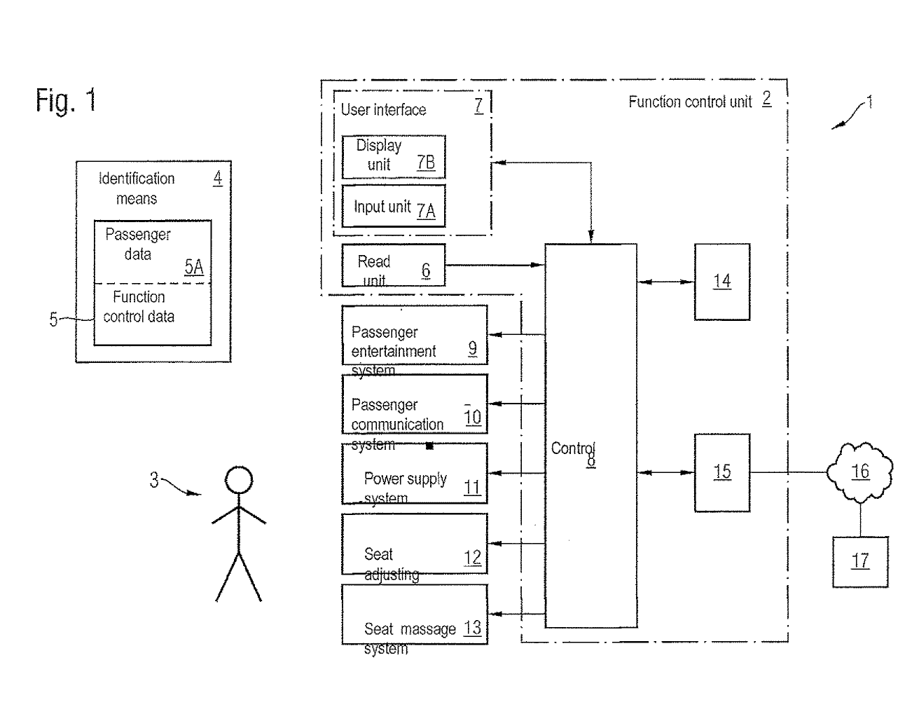

As can be seen in FIG. 1, a cabin management system 1 according to the invention has at least one function control unit 2. The function control unit 2 makes individual functions available to a user or a passenger 3. In this respect, the passenger 3 is in a passenger compartment. A passenger 3 is generally in a seat in the passenger compartment. The passenger 3 carries an identification means 4, which is preferably a boarding pass or a ticket. In a preferred embodiment, the identification means 4 has a memory unit 5 which is integrated into the identification means 4. In a possible embodiment, this memory unit 5 has a first memory area 5A for storing passenger data or personal data of the passenger 3 and a second memory area 5B for storing function control data. The function control data is used for selecting or activating functions.

The identification means 4 is preferably a card which can be inserted into a read unit 6 of the function control unit 2 by the passenger 3. The card can also be a credit card, a service card or a loyalty card of the user or passenger 3. In an alternative embodiment, the passenger data and the function control data can also be read out wirelessly from the memory unit 5 of the identification means 4 via a local air interface. The identification means 4 can also be, for example an RFID tag which the user or passenger 3 carries.

As shown in FIG. 1, the function control unit 2 in the embodiment illustrated there also has a user interface 7 with an input unit 7A for inputting instructions by the passenger 3 and with a display unit 7B for displaying the functions enabled for the passenger 3. The input unit 7A is, for example a keypad and the display unit 7B is a graphic display. In an alternative embodiment, the user interface 7 is formed by a touch screen.

The user interface 7 and the read unit 6 of the function control unit 2 are connected to a control means 8, for example a microprocessor. The internal control means 8 controls, for example functions of a passenger entertainment system 9, a passenger communication system 10, a power supply system 11, a seat adjusting system 12 and a seat massage system 13. The passenger entertainment system 9 provides the user 3 with the opportunity of, for example watching films or listening to music. Using the passenger communication system, the user or passenger 3 can have a telephone conversation with a person on the ground, for example. The power supply system 11 or an in-seat-power-supply-system (ISPSS) makes it possible for the user to connect up his laptop. The seat adjusting system 12 allows the passenger 3 to individually adjust his seat. Actuators provided in the seating surface of the seat are activated by the seat massage system 13 to massage the passenger.

When the passenger 3 inserts his identification means 4, for example his boarding pass, into the read unit 6 of the function control unit 2, he is firstly authenticated by the control means 8, i.e. a check is made to ascertain whether the identification means or the boarding pass 4 is valid. In so doing, a check can also be made, for example, as to whether the passenger 3 is in the correct seat inside the passenger compartment. In a possible embodiment, a successful authentication is indicated to the user 3 by the display unit 7B. After authentication of the passenger 3, the passenger's data and the function control data can be read out from the memory unit 5 of the identification means 4 via the read unit 6 by the control unit 8 and stored temporarily in a local data memory 14 of the function control unit 2. Subject to the function control data, the control means 8 then controls the functions which are provided by the passenger entertainment system 9, the passenger communication system 10, the power supply system 11, the seat adjusting system 12 and the seat massage system 13. In a possible embodiment, the display unit 713 of the user interface 7 indicates to the user or the passenger 3 the functions which he has activated or which have been enabled for him. In a possible embodiment, the passenger 3 has the possibility of activating or deactivating further functions.

In a further embodiment, when further functions are activated, the user's fare is increased, in which case in a possible embodiment, said increased fare is written into the identification means 4 via a write unit. When the user 3 disembarks from the cabin or the passenger compartment, the user 3 then pays the increased fare or the price difference. For example, if upon boarding a coach, a user increases the range of functions he wants compared to the range he originally booked, he will pay the difference in fare which ensues from this increase when he gets off the coach. Of course, this payment can also be made during the respective journey or respective flight or at any other time.

In a possible embodiment, the control means 8 of the function control unit 2 is connected via an interface 15 to an on-board network 16, for example an LAN, to which further function control units 2 are connected. Furthermore, a server 17 for the service personnel, for example the flight attendants, can be connected to the on-board network 16.

The function control unit 2 shown in FIG. 1 is preferably fitted directly to the seat of the respective passenger 3, for example in an arm rest. In a possible embodiment, function control data of the passenger 3 stored by the identification means 4 is generated when the transport of the passenger 3 is booked and is written into the memory unit 5.

In an alternative embodiment, the function control data is generated when the passenger 3 checks in or boards and is written into the memory unit 5 of the identification means 4.

The user or passenger 3 is authenticated by means of the portable identification means 4, for example a boarding pass, a credit card, a service card or a loyalty card belonging to the respective passenger 3 which he carries. In the case of security-relevant applications, further authentication mechanisms can be provided, for example a further authentication of the user 3 using biometric body features. Furthermore, identification by means of a carried electronic identity card is possible, for example a health insurance card, a train ticket or EC card. Authentication can also be carried out, for example by a challenge-response method, it being possible for the function control unit 2 to request the input of a personal identification number. Alternatively, the user can also be requested to input a password for his authentication.

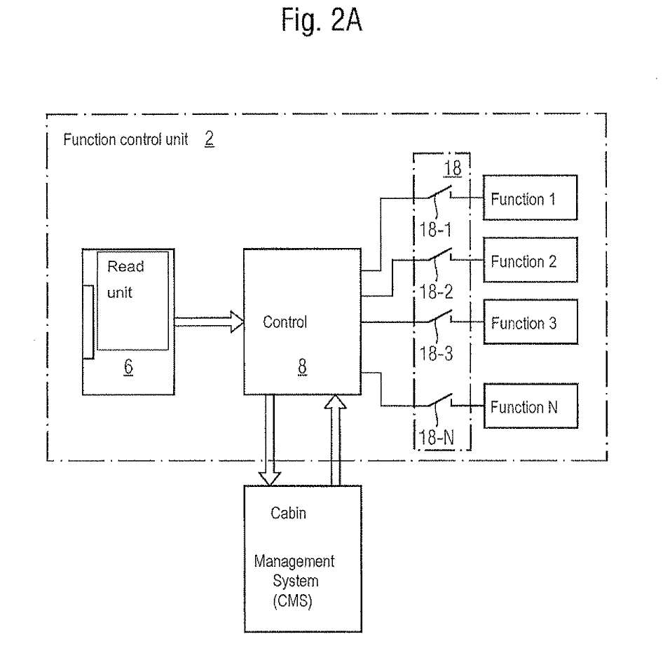

FIGS. 2A and 2B schematically show a possible embodiment of a function control unit 2 according to the invention. In this embodiment, the control means 8 controls a switching unit 18 which has a plurality of switches 18-i for switching functions on and off or for activating or deactivating functions which are made available to the passenger 3 by electronic units inside the passenger compartment, for example by the passenger entertainment system 9, the passenger communication system 10, the power supply system 11, the seat adjusting system 12 or the seat massage system 13. The control means 8 is connected to the rest of the cabin management system 1 (CMS) via an interface 15. As shown in FIG. 2A, all the service features or functions are initially deactivated. This is shown symbolically by the open switches 18-i of the switching unit 18. When a user 3 inserts the identification means 4, for example a boarding pass or any ID card into the read unit 6 of the function control unit 2, as shown in FIG. 2B, the internal control means 8 activates the switching unit 18 such that the functions are activated or deactivated according to the function control data, as stored in the memory unit of the identification means 4. In the example shown in FIG. 2B, it is stated in the memory unit 5 of the identification means 4 that functions F1, F2, EN are to be activated. The switches 18-1, 18-2, 18-N in the switching unit 18 are closed accordingly to activate the respective functions. Other functions remain deactivated. For example, in the specified example, information is stored on the identification means 4 that function 3 is not to be selected. Accordingly, the control means 8 deactivates function 3 by opening the associated switch 18-3 inside the switching unit 18.

The read unit 6 and the function control unit 2 are preferably located in the action environment of the passenger 3, for example in the back of his seat. The data can be read out by an inserted card, as shown in FIG. 2B. Alternatively, it is also possible for the data to be read out from the card 4 or the identification means 4 wirelessly via a local air interface.

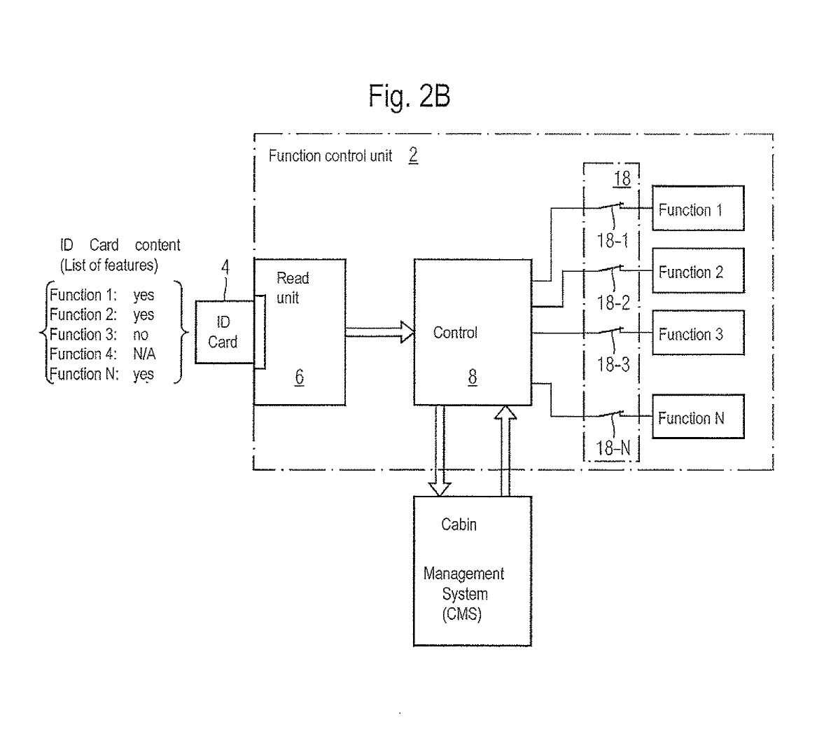

FIG. 3 shows a user 3 who has taken his place in seat 19 and is provided with functions by various electronic units. In the illustrated example, the position of the seat 19 can be adjusted by the seat adjusting system 12, for example by changing the position relative to another passenger seat in an adjacent row of seats or by adjusting angles between the seating surface and the backrest of the seat. Furthermore, in the illustrated example, an activatable power supply system 11 is provided in the arm rest. The user can watch films or listen to music, for example, via a passenger entertainment system 9. A passenger communication system 10 is also provided, by which the user 3 can telephone another person. The function control unit 2 can also be accommodated in the armrest of the seat.

In a possible embodiment, the seat space made available to the user 3 in his seat 19j is adjusted individually by the seat adjusting system 12 subject to function control data which is saved in the passenger's identification means 4 and is read out by the reader of the function control unit 2. In a possible embodiment, a user or passenger 3 can thus individually increase the seat space available to him by paying a corresponding fare increase, in that for example the distance from the row of seats in front is increased by the seat adjusting system 12. For example, as shown in FIG. 3, the distance between two seats 19i, 19j is varied according to the function control data of the user. In a possible embodiment, since the function control data was already generated when the journey was booked, it is possible, for example, to seat behind a user 3 who has individually increased his seat space, another user 3 who has agreed to a reduced seat space with a corresponding reduction in the price of the fare. In a possible embodiment, personal passenger data, for example a specified height of the user 3, is also taken into account when the seat space is adjusted. In this respect, for example a user or passenger with long legs is afforded more space than another user who has short legs. In a possible embodiment, the seat space made available to a user depends on several parameters, for example on the comfort class selected by the passenger 3, on his height specified in his personal data and on individual function adjustments.

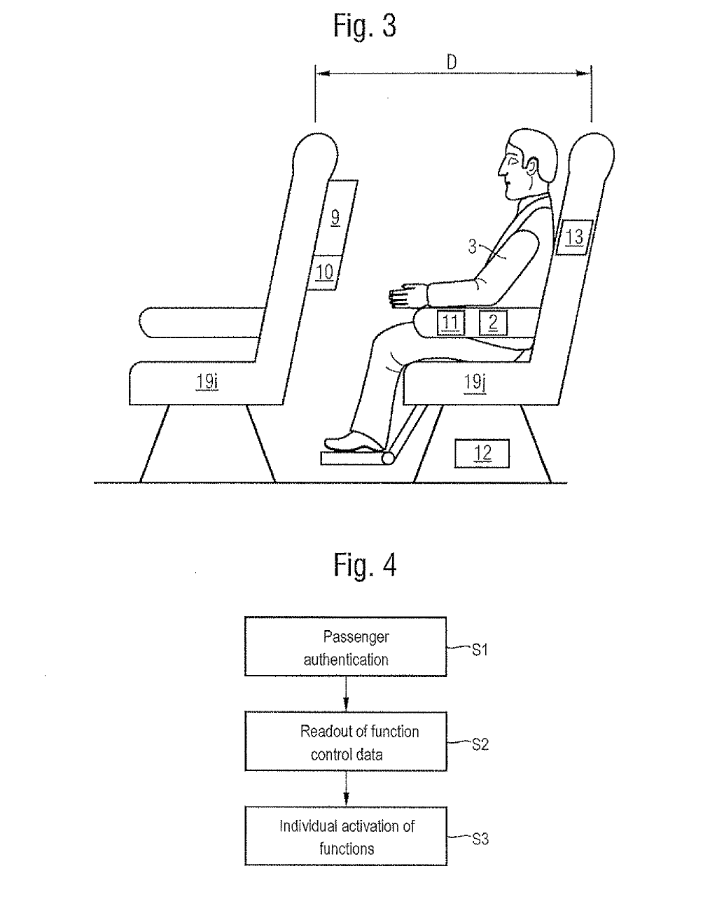

FIG. 4 shows a flow chart of a possible embodiment of the method according to the invention for making functions available to a passenger 3.

In a first step S1, the passenger 3 is authenticated to the cabin management system using an identification means 4 which he carries. Further authentication mechanisms can optionally be provided, for example authentication by biometric body features or by a challenge-response method.

In a further step S2, function control data is read out from a memory unit 5 of the identification means 4. The function control data can be read out wirelessly or by a card read unit.

In a further step S3, the control means 8 of the function control unit 2 controls individual functions subject to the function control data read out from the identification means 4.

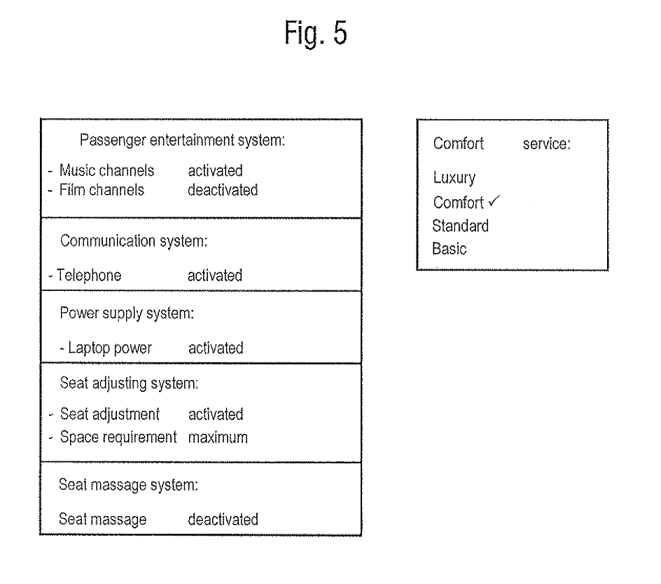

FIG. 5 shows an example of a display which a user 3 receives via the display unit 7B of the user interface 7 when his function control data is read out from the identification means 4. In the given example, the user has activated the functions of the passenger entertainment system 9, the communication system 10 and the power supply system 11. In the seat adjusting system 12, he has adjusted his desired seat requirement to “maximum”. The functions of the seat massage system 13 have been deactivated according to the function control data in the illustrated example.

Furthermore, in a possible embodiment of the function control unit 2 according to the invention, when the transport is booked, the user 3 can select a comfort service offered by the service personnel, for example the flight attendants. For example, when the passenger 3 makes a booking, he can choose between different comfort classes. The function control data is generated as a function of the selected comfort class or service class and is written into the memory unit 5 of the identification means 4. In the illustrated example, the user 3 can choose between four comfort classes, namely luxury, normal, standard or basic. In the illustrated example, the passenger 3 has selected a normal comfort or a normal service by the service personnel.

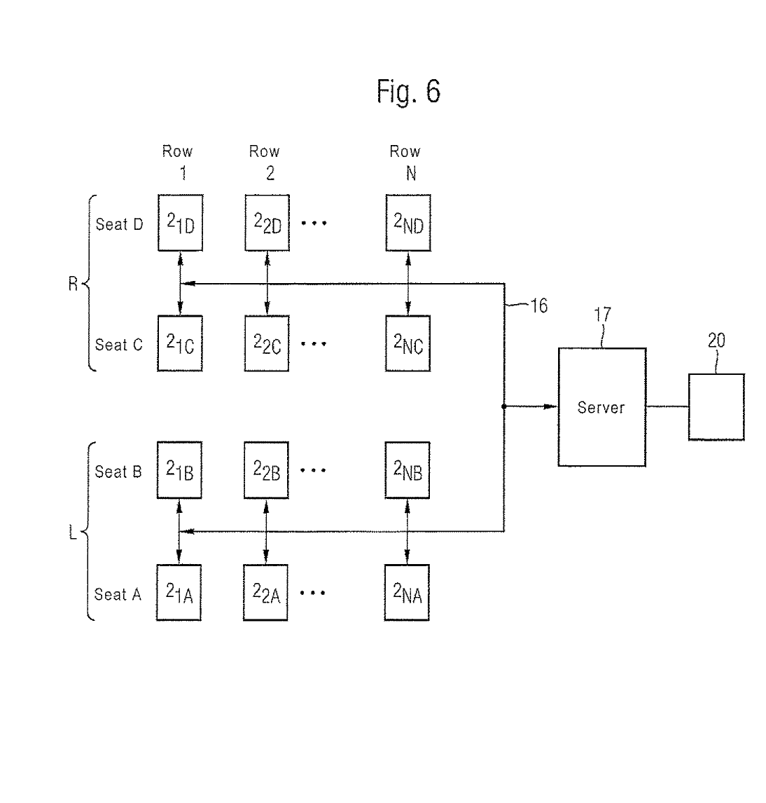

FIG. 6 shows an embodiment of a cabin management system in which a large number of function control units 2 are connected via a BUS system or in a star configuration to a server 17 for the cabin personnel. In the illustrated example, located in an aircraft are N rows of seats with in each case four seats A, B, C, D, seats A, B being arranged on the left-hand side L and seats C, D being arranged on the right-hand side R of a passenger aisle, via which flight attendants can reach the passenger 3. In a possible embodiment, the flight attendants can find out which service or comfort class the respective passenger 3 has selected via a display 20 connected to the server 17. For example, information about which comfort class the respective passengers 3 have selected can be given for a row i in the cabin.

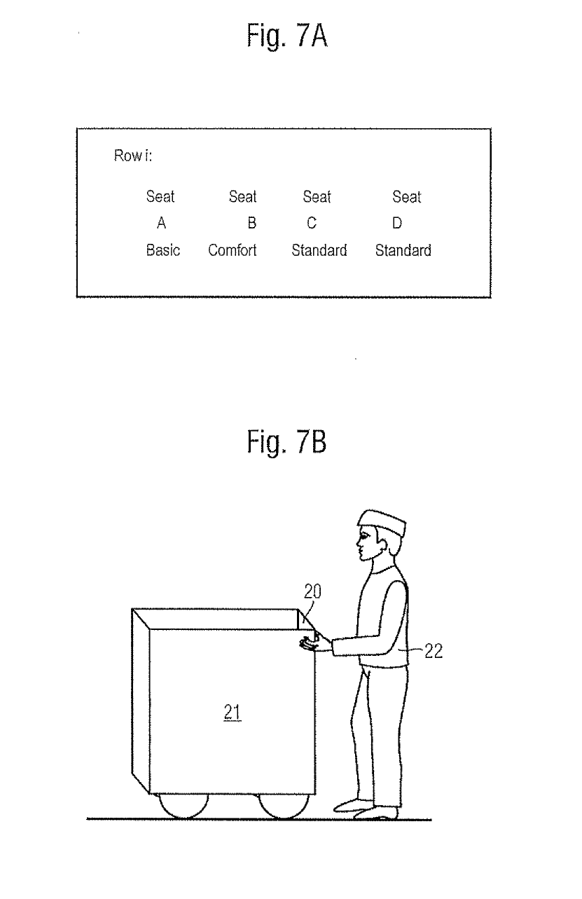

In the example shown in FIG. 7A, the two passengers on the right-hand side, i.e. in seats C and D of row i, have booked a standard service, while the passenger in seat A has only booked a basic service. The passenger in seat B of row i has chosen a comfort service. For example, in the illustrated example, the passenger in seat A is not offered food and drink by the service personnel or the flight attendants, while the passenger in seat B receives both.

In a possible embodiment, the display 20 is provided in a service trolley 21 which communicates with the server 17 for the cabin personnel via a wireless interface. In the example shown in FIG. 7B, a display 20 informs a flight attendant 22 of the service which has been booked by the passengers 3 in the row where he is presently located. In a possible embodiment, the service trolley 21 uses sensors to detect to which row or row of seats it is presently adjacent.

The cabin management system 1 according to the invention has a large number of developments or embodiments. For example, instead of being saved in a memory 5 which is integrated in the identification means 4, the function control data can also be printed on an identification means 4, in encoded form by a barcode and can be read out by a barcode reader. The identification means 4 can be an ID card which can be read out or an RFID tag, the data of which is read out wirelessly. The cabin management system 1 according to the invention is suitable for the most varied means of passenger transport, in particular aircraft, boats, coaches, trains and means of public transport.

The user 3 can be authenticated to the cabin management system 1 by the identification means 4 and additionally in other ways, in particular by inputting a password or pin number, using biometric body features or by a challenge-response method.

The functions can be selected by the user 3 while booking before the journey commences, when checking in or boarding and interactively after the user 3 has taken his seat.

In addition to including functions provided by electronic units, the selected functions can include service features which are provided by service personnel.

In a possible embodiment, the fare is adapted individually according to the selected functions and is paid, for example when the passenger alights or during the journey or flight.

The functions can be selected in an interactively menu-controlled manner. If the functions are allocated and in particular if the seat space is adjusted individually for different users 3 before the journey commences, for example during booking, the seats of different users 3 can be allocated according to the comfort range they have selected, so that for example a user 3 who requires a large amount of space is seated in a row of seats in front of a user 3 who has selected a small amount of space.

The cabin management system according to the invention enables individually personalised service features for the passenger in the cabin.

A modular configuration of the fare, in particular of the price of the flight allows the operator to cater for a relatively wide range of customers and to meet their individual needs. For example, an airline can cover a range from the absolute low cost customer to the premium customer and offer flights accordingly.

The advantage for the user or customer is that he can influence his personal flight price and service features, which he would not use anyway, or can deselect and ultimately does not have to pay for.

In a possible embodiment, stored on the identification means 4 is a service catalogue which the user 3 pays for when he books and which he can use during the flight. In a possible embodiment, the functions or service features selected by the user 3 can be evaluated statistically by the operator of the means of transport, for example the airline, in order to optimise its range of products.

The cabin management system 1 according to the invention also makes it possible for the airline to dispense with the hitherto strict division between service classes, i.e. between first class, business class and economy class and in this manner to increase the capacity utilisation of the flight.

In a possible embodiment of the cabin management system 1 according to the invention, in addition to stating conventional cabin functions or service features, a user can also specify whether he would be prepared, for appropriate remuneration, to give up his seat on the aircraft at the gateway on the approach to the aircraft, or even when he has already taken his seat on the aircraft to make room for another passenger (passenger acceptance to deboard). To increase the capacity utilisation, airlines routinely overbook flights, in other words more passengers are accepted than can actually be accommodated on the aircraft. When a flight is overbooked, in many cases a request is made for passengers who are prepared to take a later flight for appropriate remuneration so that other passengers can take their place. In a possible embodiment, the willingness of a user 3 to do this is saved as an item of function control data or flight in the identification means 4. For example, even when a user 3 of this type is already in his seat, he can receive an indication via the user interface 7 that another passenger would like to have his seat. In this manner, an airline is able to further increase the capacity utilisation of a flight.

1. A cabin management system for functions which are provided within a passenger compartment, said system comprising:
in each seat of a passenger a function control unit which has a switching unit for switching individually functions for the respective passenger on and off,
wherein the passenger is authenticated by identification means with respect to said cabin management system,
said function control units being connected by means of an on-board network to a server which communicates via a wireless interface with a service trolley comprising a display indicating a comfort class selected by the respective passenger to a flight attendant.

2. The cabin management system according to claim 1, wherein the service trolley comprises sensors to detect to which row of seats it is presently adjacent.

3. The cabin management system according to claim 1, wherein said identification means comprises a memory unit for storing the passenger's personal data and function control data for selecting functions.

4. The cabin management system according to claim 1, wherein said function control unit comprises a read unit for reading out the passenger's personal data stored on the identification means and the function control data.

5. The cabin management system according to claim 1, wherein said identification means is a boarding pass, a credit card, a service card or a loyalty card belonging to the respective passenger.

6. The cabin management system according to claim 1, wherein said switching unit is provided for switching functions on and off which are made available to the respective passenger by electronic units within the passenger compartment.

7. The cabin management system according to claim 1, wherein said function control units comprise each a user interface with an input unit for inputting instructions by the passenger and a display unit for displaying functions which have been enabled.

8. The cabin management system according to claim 1, wherein the functions are provided by an electronic passenger entertainment system, a communication system, a power supply system, a seat adjusting system and a seat massage system.

9. The cabin management system according to claim 8, wherein a seat space made available to a passenger in a seat is individually adjusted by the seat adjusting system subject to function control data which is saved on the passenger's identification means.

10. The cabin management system according to claim 4, wherein in that the passenger's personal data and the function control data are generated when the passenger's transport is booked or when the passenger checks in and are written into the memory unit of the identification means.

11. The cabin management system according to claim 3, wherein the function control data is generated as a function of the selected comfort class and is written into the memory unit of the identification means.

12. An aircraft having a cabin management system according to claim 1.

13. A method for making functions available to a passenger which comprises the following steps:
(a) authentifying a passenger by an identification means carried by the passenger,
(b) reading out function control data saved on the identification means, by a function control unit,
(c) activating individually functions by said function control unit subject to the function control data read out from the identification means.

14. The method according to claim 13, wherein the function control data is generated when the passenger's transport is booked or when the passenger checks in and is written into the identification means.

15. The method according to claim 13, wherein the function control unit is connected to a server which communicates with a service trolley displaying a comfort class selected by the passenger.

16. The method according to claim 13, wherein a seat space made available to the passenger in a seat is individually adjusted subjected to the function control data read out from the identification means.
